(19) United States
(12) Patent Application Publication
(10) Pub. No.: US 2021/0312471 A1
(43) Pub. Date: Oct. 7, 2021

(54) Systems and Methods to Prevent Counterfeiting

(71) Applicant: Avery Dennison Corporation, Glendale, CA (US)

(72) Inventor: Pradeep S. IYER, Lakewood, OH (US)

(21) Appl. No.: 17/264,865

(22) PCT Filed: Jul. 30, 2019
(86) PCT No.: PCT/US2019/044021

§ 371 Date: Feb. 1, 2021

Related U.S. Application Data
(60) Provisional application No. 62/712,269, filed on Jul. 31, 2018.

(51) Int. Cl. G06Q 30/00; G06K 19/08; G06K 7/10

(52) U.S. Cl. CPC G06Q 30/0185; G06K 19/086; G06Q 50/28; G06K 7/10386; G06K 2007/10514; G06K 7/10871

(57) ABSTRACT

System and method for using one or more entropically configured distinct physical features (a “IDENTROPY”) for establishing trust, accountability, and transparency with respect to physical items are disclosed. Such system and method are useful, among other things, for detecting counterfeit physical items.

### CROSS-REFERENCE TO RELATED APPLICATION

The present application claims the benefit of U.S. Provisional Patent Application No. 62/712,269 filed Jul. 31, 2019, which is incorporated herein by reference in its entirety.

### FIELD OF THE INVENTION

The invention relates generally to systems and methods for using entropically configured distinct physical features (an “IDENTROPY”) and securely associating or tethering the IDENTROPY to a thread of digital life history (“digital twin”) for establishing trust, accountability, authenticity, and transparency of goods, such as goods in commerce, documents, packaging etc.

### BACKGROUND OF THE INVENTION

Counterfeiting involves the manufacturing and/or distribution of goods under someone else's name or another company's brand without their permission. Counterfeit goods (e.g., “fakes” or “knock offs”) are generally made from lower quality components in order to sell a less expensive imitation of goods produced by brands that consumers know and trust. Counterfeit or pirated goods span multiple industries including luxury goods and apparel, accessories, music, software, medications and medical devices, tobacco products, cannabis products, wine and spirits, consumer goods, toys, fresh produce, and electronics.

Counterfeiting is a significant issue, both in the developed and developing world. The Organization for Economic Cooperation and Development (OECD) and the European Union Intellectual Property Office (EUIPO) reported that trade in counterfeit and pirated goods amounted to 2.5%, or USD 461 billion, of international trade in 2013. The percentage in Europe alone was 5% of imported goods in 2013, which equates to USD 116 billion. In fiscal year 2013, the United States Department of Homeland Security (DHS) seized counterfeit good values at over $1.7 billion dollars at U.S. borders.

Counterfeit goods can put both sellers and consumers at risk. For example, counterfeit goods are often made using cheap, substandard, and/or dangerous components that can put the health and safety of consumers at risk. Purchasing goods from counterfeit websites can put consumers at risk for identity theft and financial fraud when consumers provide a counterfeit merchant with personal or financial information.

Knowingly selling and purchasing counterfeit goods is illegal. In the United States, knowingly selling and buying counterfeit goods is a state and federal crime and individuals can be subject to civil and criminal penalties. The sale and purchase of counterfeit goods can undermine municipal services since counterfeiters typically do not pay fees and taxes. Counterfeit goods are often manufactured in locations without laws providing for adequate wages and worker safety and may involve forced or child labor.

Organized crime syndicates are increasingly involved in the manufacture and sale of counterfeit goods. Proceeds from these transactions can be used to further support organized crime and other illicit activities such as drug trafficking and terrorism.

Finally, legitimate manufacturers (e.g., brands) devote significant resources to the research and development of products and building a reputation for quality among consumers. Counterfeiters, in turn, seek to profit unfairly off of another company's good name. The lost sales and profits that result from this unfair competition translate directly into lower wages and lost jobs, as well as higher prices for consumers.

Current anti-counterfeiting technologies use tags or labels that are the result of deterministic processes. Such tags typically have low complexity and high predictability, which means the tags can be readily copied by counterfeiters. More complex tags have been developed, but these tags are typically too expensive to be incorporated into many types of consumer products.

There exists a need for improved systems and methods for tracking the identity, authenticity, and security of physical items, such as products and equipment, in a cost effective manner. The systems and methods described herein are directed toward these, as well as other, important ends.

### SUMMARY OF THE INVENTION

The methods and systems described herein include one or more entropically configured distinct physical features (an “IDENTROPY”) that serve as unique identifiers for a physical item, such as a product or device, particularly products and/or devices in commerce, documents, packaging, etc.

In some embodiments, the IDENTROPYs are based on physical variations that occur naturally (e.g., randomly or entropically) during manufacturing or the article, such as the scatter or splatter pattern resulting from the printing of a label, text, and/or graphic on the article; the scatter or splatter pattern resulting from printing text and/or graphic on a tag or label attached to the article; unique, random patterns in paper fiber orientation within the label or tag; and/or unique topography of a surface of the article or label or tag on the article. For example, print defects that are intrinsic on the article itself or labels or tags attached to the article (such as inkjet drop splatter) provide a unique distribution of dot size, shape, and spacings, when imaged at appropriate resolution.

A surface of the article or a surface of the tag or label attached to the article may have a unique topography. The topography may be of the substrate itself (label stock, etc.) or a material applied to it (patterned adhesive, inks, dyes, etc.). Likewise, the unique patterns in paper fiber orientation within a label or tag may be used to analyze and compare with stored information in a database.

These unique patterns may be recorded and compared to a database with known images or patterns (e.g., reference patterns) to establish a veracity or trust score or trust quotient.

In some embodiments, the IDENTROPY contains or includes a random scatter or splatter pattern that is generated by the application of a material, such as an ink, dye, pigment, adhesive, etc. to the article or to a label attached to the article that is impossible to duplicate. In some embodiments, the IDENTROPY containing the random scatter or splatter pattern on the article or on a tag or label attached to the article is visible to the naked eye on a macro scale but requires magnification to observe the random scatter or splatter pattern. This is referred to as a scatter- or absorbance-based IDENTROPY. In some embodiments, the material (e.g., ink, dye, pigment, adhesive, etc.) contains one or more additives which, upon excitation by a source (e.g., external excitation source) emit electromagnetic radiation in one or more part of the electromagnetic spectrum. The radiation may be emitted in the visible range of the spectrum (but requiring magnification to observe the pattern), or the UV or IR ranges of the spectrum which can be detected with the appropriate microscope or other device in order to observe and record the pattern. Examples include, but are not limited to, luminescence or phosphorescence.

The systems and methods described herein should allow for rapid reading and storing of the IDENTROPYs including or containing a scatter or splatter pattern(s) described herein. In one embodiments, the device used to read or image the IDENTROPYs described herein allows for rapid reading of the pattern, e.g., less than about 5, 4, 3, 2, 1, 0.75, 0.5, 0.25. 0.1, 0.05, or 0.025 seconds or less. In other embodiments, the reading or imaging of the pattern(s) and electronic storing thereof occurs in less than about 5, 4, 3, 2, 1, 0.75, 0.5, 0.25. 0.1, 0.05, or 0.025 seconds or less. The reading of the information can be done roll-to-roll (i.e. while winding and/or unwinding of rolls of materials typically done during manufacturing/printing of labels), in sheet-fed mode (where the article is dispensed in the form of cut sheets) or in a static mode, when each sheet/label is held motionless long enough to read/write with the quality required for performing authentication with a sufficient level of veracity.

In some embodiments, the article does not contain a pointer indicating a location where the IDENTROPY can be accessed/imaged (i.e., in such embodiments, the IDENTROPY is invisible to the naked human eye or “covert”).

The IDENTROPYs described above can be read, scanned, or imaged by a variety of devices known in the art including, but not limited to, hand held devices, such as a smart phone, tablet, or other hand held device; or more permanently installed devices or equipment that can be installed at the manufacturing site, in shipping containers or at shipping docks, in transportation vehicles, such as planes, trains, boats, and trucks, or at retail locations. The hand held devices, such as a smart phone, may be fitted with an appropriate lens, such as a macro lens, or a microscope, to facilitate reading or imaging of the scatter or splatter pattern. The hand held devices may be used by the manufacturer, the shipper/receiver, the retailer, and/or consumers.

In one embodiment, the IDENTROPY is a random scatter or splatter pattern of one or more materials, such as inks, adhesives, or combinations thereof, that are applied directly to the object and/or applied to a label or tag that is affixed or attached to an object. At the time the random scatter pattern is generated (or at some point later), the scatter or splatter pattern is imaged and stored in a database or distributed ledger. The object can be tracked from manufacture to sale by imaging the object at any point in the supply chain and comparing the scatter or splatter pattern on the object or on the label affixed or attached to the object to the scatter or splatter pattern stored in the database.

The scatter or splatter patterns described herein may be used alone or in combination with other IDENTROPYs. Technologies that can be used to impart additional IDENTROPYs include, but are not limited to, holograms, optically-variable inks (such as those available from Tukan at https:www.tukan.io and GE for 3D printing), security threads, barcodes, QR codes, serialization of RFIDs, NFCs, unique patterns in radiofrequency signals, and combinations thereof, and the like.

The systems and methods described herein may also contain sensors that measure or record geo-temporal data or environmental data (e.g., temperature, humidity, etc.) which may be important for articles that are time sensitive, are restricted from certain locations, and/or are sensitive to environmental conditions.

Examples of materials applied directly to an object include, but are not limited to, print, text, or logos on clothing (e.g., authentic sports jerseys, luxury clothing, etc.), shoes, accessories (hand bags, etc.), documents, and packaging. Examples of materials applied to labels that are affixed or attached to objects include labels or tags attached to clothing, shoes, accessories, wine and spirits, tobacco and cannabis products, pharmaceutical products and medical devices, fruits and vegetables, packaging, etc. Such scatter patterns can be used in combination with one or more other IDENTOPYs, such as those discussed above, and/or a tamper evident systems (e.g., for labeling, packaging, etc.) to introduce additional security elements.

The one or more IDENTROPYs make it possible to identify, authenticate, and track products and devices from cradle to grave and may be used in a variety of applications, including but not limited to detecting counterfeits, confirming identity, tracking geotravel, component/ingredient sourcing, manufacturing history, providing “how to use” information (post purchase to users), tracking asset ownership/transfer trail, tracking shipping conditions (such as temperature and humidity tracking) and establishing trust, accountability and transparency.

The systems and methods described herein allow for the tracking and authentication/verification of individual articles or objects that may be part of a larger group of the same objects. For example, the scatter pattern of ink applied to a tag or label that is affixed to luxury goods such as clothing or the scatter ink pattern of ink applied directly to an object, such as a hand bag, allows for the tracking of that single object throughout its life cycle and the supply chain. The tracking and authentication/verification can be done using a hand held as described above or a more permanently installed device or equipment in a warehouse, on a truck, plane, train, or ship, or in a retail location. Consumers themselves may also verify that their purchase is authentic using the same systems and methods.

The IDENTROPYs described herein can be used in combination with other anti-counterfeiting and/or tamper evident systems to introduce additional security elements. For examples, the articles may have applied thereto one or more labels that have a tamper evident feature.

In some embodiments, the system is a decentralized system containing:
a plurality of individual physical items, each with one or more entropically configured distinct physical features (“IDENTROPY”);
a cloud-based, shared, immutable ledger for associating each of individual physical items; and
a database for comparing said individual physical item with at least one known parameter to generate a veracity score for said individual physical item.

In some embodiments, the method is a method of identifying a physical item, including:
associating an inception certificate to the physical item;
associating the inception certificate with a shared, immutable ledger;
wherein the inception certificate is derived from entropic physical and digital randomness associated with the physical item; and
optionally, providing a veracity score for the item, when inquired or requested by a user.

### DESCRIPTION OF THE INVENTION

### I. Definitions

“Blockchain” as used herein means a growing list of records, called blocks, that are linked using cryptography. Each block contains a cryptographic hash of the previous block, a timestamp, and transaction data. By design, a blockchain is resistant to modification of the data

“Database” as used herein means an organized collection of data, generally stored and accessed electronically from a computer system. The database can be hosted locally (e.g., on a machine or server) or can be cloud-based.

“Digital Twin” as used herein means a digital or virtual copy of a physical article or articles (e.g., products, documents, packaging, etc.).

“Distributed ledger” as used herein means a consensus of replicated, shared, and synchronized digital data geographically spread across multiple sites, countries, or institutions. There is no central administrator or centralized data storage.

“IDENTROPY” as used herein means a entropically configured distinct physical feature that serves as a unique identifier for a physical item.

“Reference image” as used herein means the image created at the time the article is manufactured (or tagged or labeled).

“Scatter pattern” or “Splatter Pattern” as used herein means the random pattern resulting from the spatter of one or more materials, such as inks, dyes, pigments, adhesives, etc. during application to an article or a tag or label applied to the article.

“Trust quotient” as used herein refers to the confidence level that an article is authentic.

### II. Systems and Methods of Authentication and Tracking Articles

A. IDENTROPY

The systems and methods described herein include one or more IDENTROPYs as a means for authenticating and tracking articles, such as goods in commerce, documents, authentic brand packaging, etc. In some embodiments, the IDENTROPY is a random pattern that is generated during manufacture of the article. In some embodiments, the random pattern is the splatter or scatter pattern of ink and/or another material (e.g., dyes, pigments, adhesives, etc.) that is applied to the article during manufacture, or is applied to a tag or label that is attached to the article, and which can be read or imaged (e.g., optically). In other embodiments, the random pattern is an absorbance pattern. In some embodiments, one or more additives can be incorporated into the material which emit electromagnetic radiation in part of the spectrum outside the visible range (UV, IR, etc.). In some embodiments, the additives cause the pattern to luminesce or phosphoresce. Examples of such applications include printing the brand, size, material from which the article is made, texts or graphics that are applied to the article (logos, images, etc.), or combinations thereof. In other embodiments, the patterns described above are generated when a tag or label which is affixed to the article is prepared. The materials that can be used to generate the pattern are the same as above, namely inks, dyes, pigments, adhesive, etc. Once the pattern is generated, it is imaged and stored in a database or distributed ledger as a reference image. It is against this reference image all subsequent images will be compared in order to confirm the authenticity of the article as well as trace it during its supply chain.

A variety of conventional inks can be used. For example, conventional inks useful for inkjet applications can be used. Such inks include, but are not limited to, dye-based or pigment-based inks. Dye-based inks typically refer to dyes dissolved in a carrier, such as an aqueous carrier while pigment-based inks typically refer to pigment particles suspended in a carrier. In place of, or in addition to, conventional inkjet inks, thermochromic and/or photochromic inks can be used. Thermochromic ink is a type of ink that changes color with the application (or removal of heat). For reversible thermochromic inks, the color will revert when the temperature returns to its original level. For irreversible thermochromic inks, the color remains constant after a change in temperature. Photochromic ink is a type of ink that change color when the intensity of incoming light changes. For example, the ink can change from colorless to colored upon exposure to UV light and then fade back to colorless when the light source is removed. Such inks can be used in combination with other security features as described above, such as QR codes. Combinations of QR codes with functional inks are described in Gloric et al., Sensors, 19, 586 (2019).

Other IDENTROPYs include topography of the article, document, or tag or label substrate or topography of a material applied to the article, document, or tag or label, such as inks, dyes, pigments, and/or adhesives. For example, the random pattern of a discontinuous layer of an adhesive can be a unique identifying feature.

B. Means for Imaging the IDENTROPY

The IDENTROPY described above can be read or imaged using a variety of techniques known in the art. For example, in some embodiments, the IDENTROPY is a scatter or splatter pattern that is imaged visually using a macro lens or microscope in order to capture fine detail of the scatter or splatter pattern. In some embodiments, the IDENTROPY contains one or more additives which emit electromagnetic radiation in one or more part of the electromagnetic spectrum. For example, in some embodiments, the one or more additives can be excited using an excitation source and the resulting emission of radiation (e.g., luminescence or phosphorescence) can be imaged using an appropriate device, such as a fluorescence microscope.

Whatever the method of imaging, it should efficient and easy to use. For example, in some embodiments, the IDENTROPY imaged using a handheld device fitted with an appropriate lens (e.g., macro lens) or microscope in order to image the IDENTROPY. Suitable handheld devices include, but are not limited, smart phones, tablets, application-specific device (e.g., designed and manufactured specifically to image the IDENTROPY). In other embodiments, the IDENTROPY can be imaged using a device or piece of equipment installed in a particular location, such as warehouse, shipping container, transportation vehicle (train, boat, truck, etc,), retail location, etc. Such devices or equipment can be set up to image a large number of articles, e.g., designed to image the IDENTROPY of articles moving along a conveyor belt.

In addition to ease of use, the method for imaging the IDENTROPY should also be rapid. The IDENTROPY should be imaged and stored in a matter of seconds or less in order for the systems and methods described herein to be efficient and economically feasible. In some embodiments, the time required to image the IDENTROPY is less than 5, 4, 3, 2, 1, 0.75, 0.5, 0.25. 0.1, 0.05, 0.025, 0.01, 0.005, 0.0025, 0.001 seconds or less. In some embodiments, the time required to image the IDENTROPY and store the image in a data base and/or distributed ledger is less than 5, 4, 3, 2, 1, 0.75, 0.5, 0.25. 0.1, 0.05, 0.025, 0.01, 0.005, 0.0025, 0.001 seconds or less.

C. Systems and Methods for Authentication

As discussed above, the IDENTROPY can be imaged using a variety of techniques known in the art. Once the IDENTROPY is imaged, the image is stored electronically in a database, which is locally hosted or cloud-based or in a distributed ledger, such as a blockchain. A blockchain is a sequence of blocks or groups of transactions that are “chained” together and distributed among its users. It works as an immutable record of transactions that do not require an external authority to validate the authenticity and integrity of the data. The initial image(s) of the IDENTROPY(s) that is(are) generated serve(s) as a “reference image(s)” against which subsequent images are compared to authenticate the item(s). For example, luxury items, may have one or more identifiers printed or stamped inside or on the article. At the time of this printing or stamping, the random pattern generated by the printing or stamping (IDENTROPY) can be imaged on each article and the images stored electronically for future comparison. When one wants to authenticate an item, one compares an image taken from the item on hand and compares it to the collection of reference images to confirm the article is authentic. Likewise, a tag or label that is printed or otherwise treated to generate a random pattern (IDENTROPY) can be imaged and stored and used for comparison as described above.

In some embodiments, the comparison of an image taken from an article on hand to a reference image generates a trust quotient that can be derived or calculated using statistically. For example, in some embodiments, the systems and methods contain two or more security or anti-counterfeiting measures (a composite system). For example, in some embodiments, the two or more features are serialization (e.g., RFID) and one or more IDENTROPYs (e.g., ink splatters). In one embodiment, the trust quotient (TQ) can be calculated using the following equation:

TQ=Function[(F_intrinsic), (F_extrinsic), (F_geo-temporal trace of its digital twin), (F_tamper trace)] divided by the [System Noise]

Where,

F_intrinsic refers to entropic signature intrinsic to a material e.g. the intricate surface topography, paper fiber orientation, etc

F_extrinsic refers to primary or secondary additions derived from handling e.g. inkjet drop splatter, addition of unique tracers (Tukan/DUST), etc

F_DigiTwin refers to the ability to leverage the tethered digital information that is derived from the location (geo) and temporal(time) or even integrated social media sources arising from recording these digital information signature tracks to validate/repudiate a given item level serial.

The exemplary equation above provides a mathematical means to measure the kurtosis from order parameters derived from spatial complexity on the physical entity (in statistical mechanics referred to as “configuration entropy”) to provide the end user with a means of quantifying the confidence level with respect to the authenticity of the article. One of ordinary skill in the art will recognize that the equation above can be changed or modified as needed to account for the variables in a specific system in order to calculate a trust quotient.

The trust quotient (TQ) reflect the aggregate measure of voracity that helps the end user “connect the dots” as an article proceeds through its life cycle (manufacture, supply chain, sale, and use). One example of this is the concept of digital twins. A digital twin is a digital or virtual copy of a physical article or articles (e.g., products, documents, packaging, etc.). Digital twins connect the real and virtual world by collecting real-time data from sensors or security features. The systems and methods described herein can provide geo-temporal data in addition to authentication by scanning the article at various points within the supply chain. This can be important for articles that are sensitive, to temperature/humidity. As described herein, the data can be locally decentralized, centrally stored in a cloud, or stored in a distributed ledger (e.g., a blockchain). The data can be evaluated and simulated in a virtual copy of the assets. Data received from the simulation are applied to real assets and can help in optimizing the supply chain of the real assets (e.g., exposure to high temperatures and/or humidities, locations, etc.) and/or evaluate the robustness of anti-counterfeiting measures.

In some embodiments, the trust quotient provides the individual (e.g., retailer, consumer, etc.) with a degree or level of certainty (e.g., confidence level) that the article on hand is authentic. In some embodiments, the trust quotient is at least 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.95%, 99.99% or higher.

As discussed above, in some embodiments, the IDENTROPY includes or contains a scatter or splatter pattern on a tag or label attached to the article. In such embodiments, the tag or label and/or the article may contain additional security features in the event the tag or label is removed (either intentionally or unintentionally) in order to authenticate and track the article. These can be referred to as a composite system.

In some embodiment, the article (or package or document) itself or the label or tag attached to the article contains two or more IDENTROPYs. In some embodiments, one of the IDNTROPYs is an ink splatter pattern or topography.

In some embodiments, the label or tag contains one IDENTROPY or other security feature and the article contains another IDENTROPY or security feature. The spatial arrangement of these features to each other produces a unique signature which is lost if the tag or label is removed. Examples of such systems are described in U.S. Patent Application Publication No. 2009/0218401.

In another embodiment, the article or tag or label contains one IDENTROPY that contains a scatter or splatter pattern or topography and the article and the tag or label contain an RFID inlay with different radio frequencies. The particular pattern produced by the different frequencies is unique to that combination of label or tag and article. Removal or replacement of the label or tag results in destruction or a change in the pattern. In another embodiment, a functional portion contains or is a security element that in combination with the tag or label creates a unique reference pattern. Removal of the tag or label destroys or changes the reference pattern. Examples of such modified functional portions are described in U.S. Pat. No. 9,996,996.

In some embodiments, the composite system is a serialization feature, such as RFID, and one or more of the IDENTROPYs described herein, such as ink splatter patterns. More and more jurisdictions are requiring serialization as a means for track various goods in commerce. However, as discussed above, serialization can be counterfeited. Combining serialization with one or more of the IDENTROPYs described herein, such as ink splatter patterns, provides a second feature that is impossible to reproduce while satisfying the requirements of various statutes.

In other embodiments, the composite system includes the topography of a substrate, such as the label material (facestock, topcoat, etc.) or a surface of the article or document in combination with one or more of the IDENTROPYs described herein, such as ink splatter patterns. The topography and the IDENTROPY can be imaged and stored for comparison to a reference in order to confirm authenticity.

D. Articles to be Authenticated

The systems and methods described herein can be used to authentic/track a variety of articles including, but not limited to, goods in commerce and documents. Examples of articles include, but are not limited to, clothing (e.g., authentic sports jerseys, luxury clothing, etc.), shoes, accessories (e.g., hand bags, etc.), wine and spirits, tobacco and cannabis products, pharmaceutical products and medical devices, cosmetics, medical device, fruits and vegetables, etc.

Examples of documents include documents related to complex financial transactions, including letters of credit, guarantees, banker and buyer acceptance certificates, and inspection certificates, access credentials, passports, visas, drivers licenses, wills, deeds, bonds, stock certificates, and other similar articles.

In some embodiments, the systems and methods can be used to reduce, minimize or prevent the use of authentic packaging to package counterfeit goods. For example, measures which provide tamper evidence can be used to show that a package has been tampered with and therefore the article within may be counterfeit. Moreover, the packaging may contain one or more unique identifiers that associate the packaging with an authentic article therein. In such embodiments, the equation used to calculate the TQ may contain a variable for tamper/trace as shown below:

TQ=Function [(F_intrinsic), (F_extrinsic), (F_geo-temporal trace of its digital twin), (F_tamper trace)] divided by the [System Noise]

F_intrinsic refers to entropic signature intrinsic to a material e.g. the intricate surface topography, paper fiber orientation, etc

F_extrinsic refers to primary or secondary additions derived from handling e.g. inkjet drop splatter, addition of unique tracers (Tukan/DUST), etc

F_DigiTwin refers to the ability to leverage the tethered digital information that is derived from the location (geo) and temporal(time) or even integrated social media sources arising from recording these digital information signature tracks to validate/repudiate a given item level serial number or identifier.

The method also includes steps of inspecting the history and identity of the item by using private and/or public key tokens through a hashed chain of associated data.

The disclosures of each patent, patent application, and publication cited or described in this document are hereby incorporated herein by reference, in their entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

1. A method for authenticating an article, the method comprising
(a) applying one or more materials to the article or to a tag or label attached to the article to create or generate one or more entropically configured distinct physical features (IDENTROPY); and
(b) comparing the one or more entropically configured distinct physical features to a reference or references stored in a database, memory or distributed ledger.

2. The method of claim 1 comprising further establishing or calculating a trust quotient.

3. The method of claim 1, wherein the article is a good in commerce.

4. The method of claim 3, wherein the good in commerce is selected from the group consisting of luxury goods and apparel, accessories, music, software, medications and medical devices, tobacco products, cannabis products, wine and spirits, consumer goods, toys, fresh produce, and electronics.

5. The method of claim 1, wherein the one or materials are selected from the group consisting of inks, dyes, pigments, adhesives, paper, film, semi-conductor chips or combinations thereof.

6. The method of claim 5, wherein the IDENTROPY is a scatter or splatter pattern.

7. The method of claim 6, wherein the IDENTROPY is imaged optically.

8. The method of claim 7, wherein the IDENTROPY is imaged using a macro lens attached to personal device.

9. The method of claim 8, wherein the personal device is selected from the group consisting of a smart phone, a tablet, or other handheld device.

10. The method of claim 7, wherein the IDENTROPY is imaged using a device installed in a warehouse, plane, boat, train, truck, shipping container, or retail location.

11. The method of claim 5, wherein the IDENTROPY is an absorbance pattern.

12. The method of claim 11, wherein the IDENTROPY is imaged optically.

13. The method of claim 11, wherein the IDENTROPY is imaged using a macro lens attached to personal device.

14. The method of claim 13, wherein the personal device is selected from the group consisting of a smart phone, a tablet, or other handheld device.

15. The method of claim 12, wherein the IDENTROPY is imaged using a device installed in a warehouse, plane, boat, train, truck, shipping container, or retail location.

16. The method of claim 5, wherein the pattern is a luminescence pattern.

17. The method of claim 16, wherein the random pattern is imaged optically.

18. The method of claim 17, wherein the random patter is imaged using a microscope attached to personal device.

19. The method of claim 18, wherein the personal device is selected from the group consisting of a smart phone, a tablet, or other handheld device.

20. The method of claim 17, wherein the IDENTROPY is imaged using a device installed in a warehouse, plane, boat, train, truck, shipping container, or retail location.

21. The method of claim 1, wherein the reference image is stored in a database.

22. The method of claim 21, wherein the database is locally hosted.

23. The method of claim 21, wherein the database is cloud based.

24. The method of claim 1, wherein the reference image is stored in distributed ledger.

25. The method of claim 24, wherein the distributed ledger is a block chain.

26. The method of claim 1, wherein the imaging and storage is done roll-to-roll (during winding and/or unwinding), sheet-fed, or static mode.

27. The method of claim 1, further comprising incorporating one or more additional anti-counterfeiting measures, tracking measures, tamper-evident labeling systems, or combinations thereof to form a composite system.

28. The method of claim 27, further comprising one or more tracking measures.

29. The method of claim 28, wherein the one or more tracking or anti-counterfeiting measures comprises serialization.

30. The method of claim 27, wherein the one or more tracking or anti-counterfeiting measures comprises topography.

31. The method of claim 27, wherein the one or more tracking or anti-counterfeiting measures comprises fiber patterns.
